(19) United States
(12) Patent Application Publication
(10) Pub. No.: US 2024/0152975 A1
(43) Pub. Date: May 9, 2024

(54) ADVERTISING SKITS

(71) Applicant: StoryForge Inc., Apple Valley, MN (US)

(72) Inventors: Sabrina Marie Rucker, Apple Valley, MN (US); Derek Peck Rucker, Apple Valley, MN (US); Tate Lutter Bosler, Minneapolis, MN (US); Bri K. Rucker, Apple Valley, MN (US)

(21) Appl. No.: 18/498,343

(22) Filed: Oct. 31, 2023

Related U.S. Application Data
(60) Provisional application No. 63/423,988, filed on Nov. 9, 2022.

(51) Int. Cl. G06Q 30/0241

(52) U.S. Cl. CPC G06Q 30/0276

(57) ABSTRACT

A method includes receiving selection of at least one advertising placement element, which is to be included in a plurality of advertising skits each having a skit content theme, that includes selection of at least one of: a primary role placement for an advertising element and a secondary role placement for an advertising element. This method further includes receiving selection of at least one advertising alignment, for the plurality of advertising skits each having the skit content theme, that includes selection of at least one of: a hero alignment for an advertising element, an anti-hero alignment for an advertising element, and a neutral alignment for an advertising element. And, this method includes generating a first advertising skit, of the plurality of advertising skits, including a first advertising content at a first advertising element, based on the received selection of the advertising placement element, and in a first advertising alignment at the first advertising element, based on the received selection of the advertising alignment.

### RELATED APPLICATIONS

The application claims the benefit of U.S. Provisional Patent Application No. 63/423,988, filed Nov. 9, 2022, the entire contents of which are incorporated herein by reference.

### TECHNICAL FIELD

The disclosure relates to devices, systems, and methods for generating one or more advertising skits. In particular, certain embodiments disclosed herein relate to devices, systems, and methods for generating a plurality of advertising skits using one or more various input selection criteria to generate the plurality of advertising skits.

### BACKGROUND

Digital advertising can provide advantages to multiple parties. For an advertiser, digital advertising can, as one example, provide a means to market a particular good or service to a viewing audience at an efficient scale. For a digital content provider, digital advertising can, as one example, provide a means to procure an additive revenue stream, from the advertiser, to help support the costs of providing the digital content.

However, traditional digital advertising tends to be provided in a bland, uninteresting format. For example, a webpage may display a static digital advertisement at a margin of the webpage. Yet, this tendency for traditional digital advertising to be provided in a generally bland, uninteresting, and static format can detract from the value of the digital advertisement to the advertiser as a viewing audience may not be inclined to notice, or otherwise intake, the digital advertisement. As a result, this can likewise detract from the value of digital advertising to the digital content provider as the lack of viewing audience intake of the digital advertisement can result in a lower additive revenue stream.

### SUMMARY

In general, this disclosure relates to devices, systems, and methods for generating one or more advertising skits (e.g., digital advertising skits). For example, embodiments disclosed herein can generate a plurality of dynamic advertising skits using one or more various input selection criteria to generate these plurality of dynamic advertising skits. Accordingly, the plurality of dynamic advertising skits can be generated in a way that is tailored to the input selection criteria (e.g., input selection criteria from advertisers) while providing dynamic advertising content in a way that is more likely to increase viewing audience intake of the advertising content. For example, embodiments disclosed herein can generate a digital advertising skit that includes advertising content associated with one or more characters that execute a skit according to a skit content theme. This can allow for interchanging advertising content associated with one or more characters based on the input selection criteria for the advertising skit while improving viewing audience engagement so as to help increase the value of the advertising content.

Embodiments disclosed herein can be implemented, for example, using programmable processing circuitry. For example, such programmable processing circuitry can execute non-transitory computer readable instructions to cause the programmable processing circuitry to receive input from one or more parties, such as input from one or more advertisers, which input can include selection of one or more character roles and/or one or more character role alignments, and/or one or more viewers, which input can include skit themes of interest and/or input interaction with a particular advertising skit. Such programmable processing circuitry can execute non-transitory computer readable instructions to then cause the programmable processing circuitry to use this received input from one or more parties to generate a particular advertising skit, which is compliant with the received input from one or more parties, and using one or more elements retrieved from an advertising skit database. This sequence can then be efficiently repeated by the programmable processing circuitry to generate another advertising skit of the same skit content theme again compliant with the received input from one or more parties but using at least one different element retrieved from the advertising skit database. Accordingly, such an implementation can be useful in generating dynamic digital advertising skits that leverage received input from one or more parties (e.g., input from one or more advertisers and/or one or more viewers) within a repeatable and efficient framework for generating a plurality of such advertising skits that include varied elements (e.g., each of a common skit content theme) retrieved from the advertising skit database so as to help increase viewing audience engagement with the digital advertising content included at or in association with the varied elements retrieved from the advertising skit database. Moreover, the skit content theme can be changed by selecting a different skit content theme category and retrieving varied elements (e.g., each of the selected, different common skit content theme) corresponding to this selected different skit content theme category while maintaining compliance with the received input from one or more parties.

One embodiment includes a method. This method embodiment includes receiving selection of at least one advertising placement element that is to be included in a plurality of advertising skits each having a skit content theme. The received selection of the at least one advertising placement element can include selection of at least one of: a primary role placement for an advertising element across the skit content theme of the plurality of advertising skits (e.g., received selection of one or more primary role placements for one or more respective advertising elements across the skit content theme of the plurality of advertising skits), and a secondary role placement for an advertising element across the skit content theme of the plurality of advertising skits (e.g. received selection of one or more secondary role placements for one or more respective advertising elements across the skit content theme of the plurality of advertising skits). This method embodiment further includes receiving selection of at least one advertising alignment for the plurality of advertising skits each having the skit content theme. The received selection of the at least one advertising alignment can include selection of at least one of: a hero alignment for an advertising element across the skit content theme of the plurality of advertising skits, an anti-hero alignment for an advertising element across the skit content theme of the plurality of advertising skits, and a neutral alignment for an advertising element across the skit content theme of the plurality of advertising skits. And, this method embodiment includes generating a first advertising skit of the plurality of advertising skits. The first advertising skit can include the skit content theme. The first advertising skit can be generated to include a first advertising content at a first advertising element based on the received selection of the at least one advertising placement element, and the first advertising skit can be generated to include the first advertising content in a first advertising alignment at the first advertising element based on the received selection of the at least one advertising alignment.

In a further embodiment of this method, receiving selection of the primary role placement for the advertising element can include receiving selection of a main character role placement for the advertising element across the skit content theme of the plurality of advertising skits. And, receiving selection of the secondary role placement for the advertising element can include receiving selection of at least one of: a supporting character role placement for the advertising element across the skit content theme of the plurality of advertising skits, and an environment element role placement for the advertising element across the skit content theme of the plurality of advertising skits.

In a further embodiment of this method, the first advertising skit can be generated to include the first advertising content at the first advertising element and a second, different advertising content at a second, different advertising element. In one such example, the first advertising skit can be generated to include the first advertising content at the main character role placement as the first advertising element based on the received selection, from a first party, of the at least one advertising placement element being received selection of the main character role placement for the advertising element across the skit content theme of the plurality of advertising skits. And, the first advertising skit can be generated to include (i) the second, different advertising content at the supporting character role placement as the second, different advertising element based on the received selection, from a second, different party, of the at least one advertising placement element being received selection of the supporting character role placement for the advertising element across the skit content theme of the plurality of advertising skits, or (ii) the second, different advertising content at the environment element role placement as the second, different advertising element based on the received selection, from the second, different party, of the at least one advertising placement element being received selection of the environment element role placement for the advertising element across the skit content theme of the plurality of advertising skits.

In a further embodiment of this method, the method can additionally include providing the first advertising skit of the plurality of advertising skits to a remote viewing device. And, this method embodiment can additionally include receiving user input from the remote viewing device, with the received user input being associated with the first advertising skit. In a more particular such embodiment, the method can further include, when the received user input, associated with the first advertising skit, matches a first preset threshold, generating a second advertising skit of the plurality of advertising skits, with the second advertising skit including the skit content theme. For instance, this second advertising skit can be generated to include a second advertising element, which is different than the first advertising element, in place of the first advertising element, and the second advertising element can be selected based on the received selection of the at least one advertising placement element.

In a further embodiment of this method, the method can additionally include receiving, from a first party, selection of a first skit content theme category. The first skit content theme category can include a first plurality of advertising skits each having a first, common skit content theme. And, in this embodiment, generating the first advertising skit can include generating the first advertising skit as one of the first plurality of advertising skits each having the first, common skit content theme based on the received selection of the first skit content theme category.

In a further embodiment of this method, the method can additionally include receiving, from a first party, selection of a first viewer characteristic. The method can additionally include selecting a first skit content theme category from a plurality of skit content theme categories based on the first skit content theme category being associated with the received first viewer characteristic. The first skit content theme category can include a first plurality of advertising skits each having a first, common skit content theme, and the first, common skit content theme can be associated with the received first viewer characteristic. And, the method can additionally include providing, to a remote viewing device associated with the first viewer characteristic, the first advertising skit as an advertising skit selected from the first skit content theme category.

In a further embodiment of this method, the method can additionally include receiving, from a first party, selection of a skit content theme category opt-out for a first skit content theme category that includes a first plurality of advertising skits each having a first, common skit content theme. And, the method can additionally include excluding the first plurality of advertising skits each having the first, common skit content theme when generating the first advertising skit.

Another embodiment includes an apparatus having programmable processing circuitry to: receive selection of at least one advertising placement element that is to be included in a plurality of advertising skits each having a skit content theme. The received selection of the at least one advertising placement element includes selection of at least one of: a primary role placement for an advertising element across the skit content theme of the plurality of advertising skits, and a secondary role placement for an advertising element across the skit content theme of the plurality of advertising skits. The apparatus has the programmable processing circuitry to further: receive selection of at least one advertising alignment for the plurality of advertising skits each having the skit content theme. The received selection of the at least one advertising alignment includes selection of at least one of: a hero alignment for an advertising element across the skit content theme of the plurality of advertising skits, an anti-hero alignment for an advertising element across the skit content theme of the plurality of advertising skits, and a neutral alignment for an advertising element across the skit content theme of the plurality of advertising skits. And, the apparatus has the programmable processing circuitry to further: generate a first advertising skit of the plurality of advertising skits. The first advertising skit can include the skit content theme. The first advertising skit can be generated to include a first advertising content at a first advertising element based on the received selection of the at least one advertising placement element. And, the first advertising skit can be generated to include the first advertising content in a first advertising alignment at the first advertising element based on the received selection of the at least one advertising alignment.

In a further embodiment, the programmable processing circuitry of the apparatus is configured to receive selection of the primary role placement for the advertising element by receiving selection of a main character role placement for the advertising element across the skit content theme of the plurality of advertising skits. And, the programmable processing circuitry of the apparatus is configured to receive selection of the secondary role placement for the advertising element by receiving selection of at least one of: a supporting character role placement for the advertising element across the skit content theme of the plurality of advertising skits, and an environment element role placement for the advertising element across the skit content theme of the plurality of advertising skits. For instance, the programmable processing circuitry can be configured to generate the first advertising skit to include the first advertising content at the first advertising element and a second, different advertising content at a second, different advertising element. As one such example, the programmable processing circuitry can be configured to generate the first advertising skit to include the first advertising content at the main character role placement as the first advertising element based on the received selection, from a first party, of the at least one advertising placement element being received selection of the main character role placement for the advertising element across the skit content theme of the plurality of advertising skits. And, in this example, the programmable processing circuitry can be configured to generate the first advertising skit to include (i) the second, different advertising content at the supporting character role placement as the second, different advertising element based on the received selection, from a second, different party, of the at least one advertising placement element being received selection of the supporting character role placement for the advertising element across the skit content theme of the plurality of advertising skits, or (ii) the second, different advertising content at the environment element role placement as the second, different advertising element based on the received selection, from the second, different party, of the at least one advertising placement element being received selection of the environment element role placement for the advertising element across the skit content theme of the plurality of advertising skits.

In a further embodiment, the programmable processing circuitry of the apparatus is configured to: provide the first advertising skit of the plurality of advertising skits to a remote viewing device, and receive user input from the remote viewing device. The received user input can be associated with the first advertising skit. As one such example, the programmable processing circuitry can be configured to: when the received user input, associated with the first advertising skit, matches a first preset threshold, generate a second advertising skit of the plurality of advertising skits, with the second advertising skit including the skit content theme. For instance, the programmable processing circuitry can be configured to generate the second advertising skit to include a second advertising element, which is different than the first advertising element, in place of the first advertising element. And, the programmable processing circuitry can be configured to select the second advertising element based on the received selection of the at least one advertising placement element.

In a further embodiment, the programmable processing circuitry of the apparatus is configured to: receive, from a first party, selection of a first skit content theme category, the first skit content theme category including a first plurality of advertising skits each having a first, common skit content theme. And, the programmable processing circuitry can be configured to generate the first advertising skit by generating the first advertising skit as one of the first plurality of advertising skits each having the first, common skit content theme based on the received selection of the first skit content theme category.

In a further embodiment, the programmable processing circuitry of the apparatus is configured to: receive, from a first party, selection of a first viewer characteristic. The programmable processing circuitry of the apparatus is configured to: select a first skit content theme category from a plurality of skit content theme categories based on the first skit content theme category being associated with the received first viewer characteristic. The first skit content theme category can include a first plurality of advertising skits each having a first, common skit content theme, and the first, common skit content theme can be associated with the received first viewer characteristic. And, the programmable processing circuitry of the apparatus is configured to: provide, to a remote viewing device associated with the first viewer characteristic, the first advertising skit as an advertising skit selected from the first skit content theme category.

In a further embodiment, the programmable processing circuitry of the apparatus is further configured to: receive, from a first party, selection of a skit content theme category opt-out for a first skit content theme category that includes a first plurality of advertising skits each having a first, common skit content theme. And, the programmable processing circuitry of the apparatus is configured to: exclude the first plurality of advertising skits each having the first, common skit content theme when generating the first advertising skit. In a yet further embodiment, the programmable processing circuitry of the apparatus can further be configured to: receive, from a first party, selection of a specific skit opt-out for a particular skit. And, the programmable processing circuitry of the apparatus is configured to: exclude that particular skit when generating the first advertising skit. As one such example, the programmable processing circuitry of the apparatus can be configured to: receive, from a first party, selection of a skit content theme category opt-out for a first skit content theme category that includes a first plurality of advertising skits each having a first, common skit content theme. In this example, after receiving the skit content theme category opt-out, the programmable processing circuitry of the apparatus can be configured to: provide a listing of the particular, individual skits in that first skit content theme category for which the skit content theme category opt-out was received and receive user input selecting any one or more of the particular, individual skits in that first skit content theme category that are to be excluded from the skit content theme category opt-out and, thus, available for use in generating the first advertising skit.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a schematic diagram of an embodiment of a system for generating and providing a plurality of advertising skits.

FIG. 2 is a block diagram of an embodiment of a computing device for generating and providing a plurality of advertising skits.

FIG. 3 is a flow diagram of an embodiment of a method for generating an advertising skit of a plurality of advertising skits.

FIGS. 4A-4C illustrate an embodiment of a plurality of advertising skits each having a common skit content theme. FIG. 4A illustrates a first advertising skit embodiment of the plurality of advertising skits having the common skit content theme, FIG. 4B illustrates a second advertising skit embodiment of the plurality of advertising skits having the common skit content theme, and FIG. 4C illustrates a third advertising skit embodiment of the plurality of advertising skits having the common skit content theme.

FIGS. 5A-5B illustrate another embodiment of a plurality of advertising skits each having a common skit content theme. FIG. 5A illustrates a first advertising skit embodiment of the plurality of advertising skits having the common skit content theme, and FIG. 5B illustrates a second advertising skit embodiment of the plurality of advertising skits having the common skit content theme.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

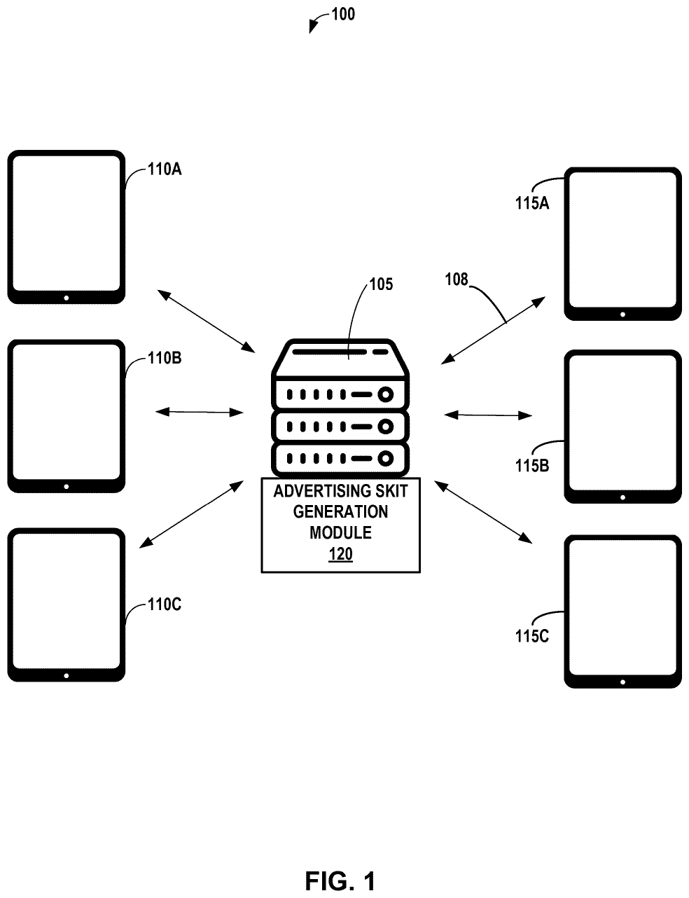

FIG. 1 is a conceptual diagram illustrating an embodiment of a system 100 for generating and providing a plurality of advertising skits, in accordance with some examples of this disclosure. The system 100 can include a variety of devices, including a computing device 105, one or more remote advertising party devices 110A, 110B, 110C, and one or more remote viewing devices 115A, 115B, 115C. The computing device 105 can be in communication with each of the one or more remote advertising party devices 110A, 110B, 110C and one or more remote viewing devices 115A, 115B, 115C via a communication channel 108 therebetween. The communication channel 108 can be a wired or wireless communication channel, such as a wide area network communication channel, such as communication over an Internet connection or cellular connection.

Computing device 105 can be any computer with the processing power required to adequately execute the techniques described herein. For instance, computing device 105 may be any one or more of a remote server, remote server system, a mobile computing device (e.g., a smartphone, a tablet computer, a laptop computer, etc.), a desktop computer, or any other computerized device that may be configured to perform the techniques described herein. In many examples, computing device 105 can be a remote server configured to communicate with remote advertising party devices 110A, 110B, 110C and remote viewing devices 115A, 115B, 115C.

Computing device 105 can include an advertising skit generation module 120 that is configured to generate a plurality of advertising skits. The advertising skit generation module 120 can execute locally (e.g., at processors 202 of computing device 105) to provide functions associated with generating a plurality of advertising skits, for instance using received inputs to generate a plurality of advertising skits each having a common skit content theme and in compliance with the received inputs. In some examples, advertising skit generation module 120 may act as an interface to a remote server accessible to computing device 105. For example, advertising skit generation module 120 may be an interface or application programming interface (API) to a remote server that generates the plurality of advertising skits each having a common skit content theme and in compliance with the received inputs.

Each of remote advertising party devices 110A, 110B, 110C can be any computing device, including personal computers, mobile computing devices, and/or one or more servers configured to receive user input thereat and convey such received user input to the computing device 105. For example, each of remote advertising party devices 110A, 110B, 110C can be a computing device used by an advertising party (e.g., remote advertising device 110A is a computing device of a first advertising party, remote advertising device 110B is a computing device of a second, different advertising party, remote advertising device 110C is a computing device of a third, different advertising party). The advertising party can be a person or entity who provides compensation to a digital content provider (e.g., a person or entity who uses the computing device 105) in exchange for the digital content provider including advertising content specified by the advertising party present in a generated advertising skit. The respective advertising party can provide one or more inputs at the respective remote advertising party device 110A, 110B, 110C, and the computing device 105 can receive and store such advertising party inputs for use in executing the advertising skit generation module 120 at the computing device 105.

Each of remote viewing devices 115A, 115B, 115C can be any computing device, including personal computers, mobile computing devices, and/or one or more servers configured to receive, from the computing device 105, a generated advertising skit and display, at the remote viewing device 115A, 115B, 115C, the generated advertising skit with the advertising content specified by the advertising party present in the generated advertising skit. For example, each of remote viewing devices 115A, 115B, 115C can be a computing device used by a third party viewer of a generated advertising skit (e.g., remote viewing device 115A is a computing device used by a first viewing party, remote viewing device 115B is a computing device used by a second, different viewing party, remote viewing device 115C is a computing device used by a third, different viewing party). The respective viewing party can provide one or more inputs at the respective remote viewing device 115A, 115B, 115C, and the computing device 105 can receive and store such viewing party inputs for use in executing the advertising skit generation module 120 at the computing device 105.

In accordance with the techniques described herein, computing device 105 can use received input from one or more of remote advertising party devices 110A, 110B, 110C and/or one or more of remote viewing devices 115A, 115B, 115C, and computing device 105 can use this received input to generate a plurality of advertising skits (e.g., a first plurality of advertising skits of a first common skit content theme; and a second plurality of advertising skits of a second, different common skit content theme). Advertising skit generation module 120 can be configured to use the received input to generate a plurality of advertising skits, for instance, such that the plurality of generated advertising skits comply with one or more rules extracted from the input received from the one or more advertising parties (e.g., via the one or more remote advertising party device 110A, 110B, 110C) the one or more viewing parties (e.g., via the one or more of remote viewing devices 115A, 115B, 115C).

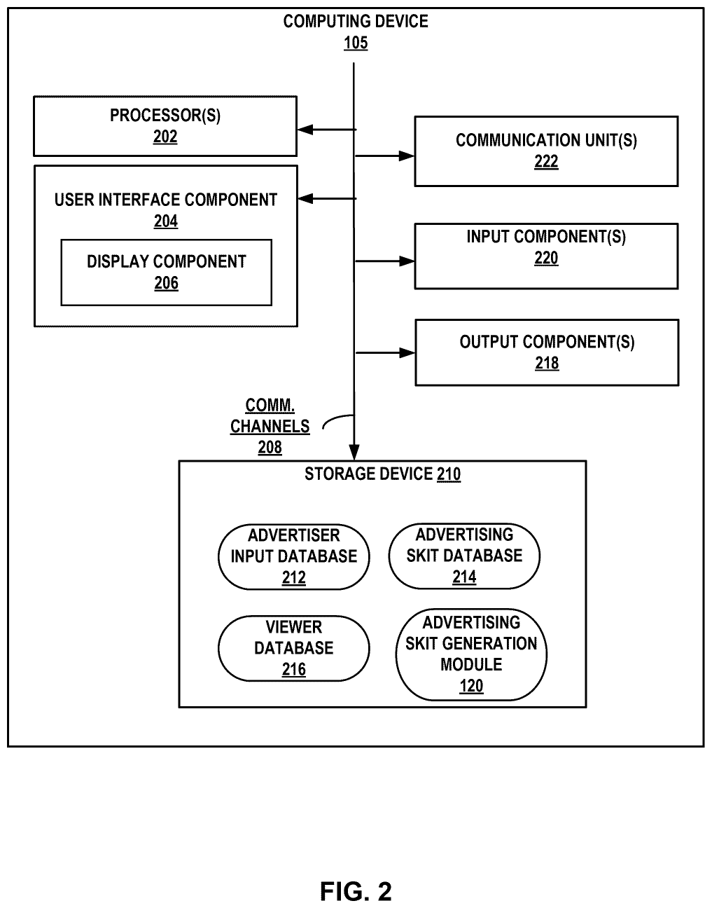

FIG. 2 is a block diagram of an embodiment of the computing device 105 for generating and providing a plurality of advertising skits, in accordance with some examples of this disclosure. FIG. 2 illustrates only one particular example of computing device 105, and many other examples of computing device 105 may be used in other instances and may include a subset of the components illustrated for example computing device 105 or may include additional components not illustrated at FIG. 2. As noted, computing device 105 can be any computer with the processing power required to adequately execute the techniques described herein.

As shown in the example of FIG. 2, computing device 105 can include programmable processing circuitry, such as one or more programmable processor(s), 202, user interface component 204 which can include a display component 206, one or more storage devices 210, one or more output components 218, one or more input components 220, and one or more communication units 222. Storage device 210 of computing device 105 can include advertiser input database 212, advertising skit database 214, viewer database 216, and advertising skit generation module 217.

One or more programmable processors 202 can implement functionality and/or execute instructions associated with computing device 105 to generate one or more advertising skits as disclosed herein. For example, one or more programmable processors 202 can implement functionality and/or execute instructions associated with computing device 105 to receive input from one or more advertising party devices and/or one or more viewing party devices, store such received input in a corresponding advertiser input database 212 and/or viewer database 216, and use such data stored at the advertiser input database 212, advertising skit database 214, and/or viewer database 216 to generate one or more advertising skits as disclosed herein. In some examples, the advertising skit database 214 can store data associated with advertising skit parameters that are input into the advertising skit database 214 by a party executing the computing device 105.

Examples of processor(s) 202 can include application processors, auxiliary processors, and any other hardware configure to function as a processor, a processing unit, or a processing device. Advertiser input database 212, advertising skit database 214, and/or viewer database 216 can be operable by processor(s) 202 to perform various actions, operations, or functions of computing device 105. For example, processor(s) 202 of computing device 105 can retrieve and execute computer readable instructions, such as computer readable instructions stored as the advertising skit generation instructions at advertising skit generation module 217, at storage device 210 that cause processor(s) 202 to perform the operations described with respect to generating and/or providing an advertising skit. The advertising skit generation instructions, when executed by processor(s) 202, may cause computing device 105 to utilize one or more data inputs saved at the advertiser input database 212, advertising skit database 214, and/or viewer database 216 to generate one or more advertising skits (e.g., with each such advertising skit generated in compliance with the data inputs saved at the advertiser input database 212, advertising skit database 214, and/or viewer database 216).

Advertising skit generation module 120 can execute locally (e.g., at processor(s) 202) to provide functions associated with generating one or more advertising skits. In some examples, advertising skit generation module 120 may act as an interface to a remote service accessible to computing device 105. For example, advertising skit generation module 120 may be an interface or application programming interface (API) to a remote server that utilizes received inputs stored at the storage device, such as stored data at one or more of the advertiser input database 212, advertising skit database 214, and viewer database 216, to generate one or more advertising skits that include one or more advertising content.

In some examples, communication unit(s) 222 may execute locally (e.g., at processor(s) 202) to provide functions associated with communicating with remote devices. In various examples, communication unit(s) 222 can be configured to receive input from one or more remote advertising party devices and/or one or more remote viewing devices and/or to transmit data to one or more remote advertising party devices and/or one or more remote viewing devices. Communication unit(s) 222 can include, for example, a wireless transceiver.

Storage device 210 at computing device 105 can store information for processing during operation of computing device 105 (e.g., computing device 105 can store data accessed by advertising skit generation module 120 during execution of the advertising skit generation instructions at computing device 105). Components at storage device 210, including advertiser input database 212, advertising skit database 214, viewer database 216, and advertising skit generation module 120, can include one or more computer-readable storage media. Such computer-readable storage media at the storage device 210 can include one or more non-transitory computer-readable storage mediums. Such storage components may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories.

Communication channels 250 can interconnect each of the components 202, 204, 210, 218, 220, and 222 for inter-component communications (e.g., physically, communicatively, and/or operatively). In some examples, communication channels 250 may include a system bus, a network connection, an inter-process communication data structure, or any other suitable means for communicating data.

One or more input component(s) 220 of computing device 105 can receive user input at the computing device 105. Examples of input are tactile, audio, and video input. Input component(s) 220 of computing device 105 can be used to provide user input to the computing device, for instance, in specifying one or more operations or data aggregations to be executed. For example, input component(s) 220 can be configured to receive user input specifying a data report to be generated using data stored at any one or more of advertiser input database 212, advertising skit database 214, and viewer database 216.

One or more output component(s) 218 of computing device 105 may generate output in a selected modality. Examples of modalities may include a tactile notification, audible notification, visual notification, machine generated voice notification, or other modalities. Output component(s) 218 of computing device 105, in one example, can include any suitable type of device for generating output to a human or machine in a selected modality. As one such example, output component(s) 218 can be configured to output to a human viewer or machine readable device data from any one or more of advertiser input database 212, advertising skit database 214, and viewer database 216.

User interface component 205 of computing device 105 can include display component 206. Display component 206 can be a digital display screen at which information (e.g., a visual indication) is displayed by user interface component 204 to a user of the computing device 105. Display component 206 can, for example, display data from any one or more of advertiser input database 212, advertising skit database 214, and viewer database 216.

In accordance with the techniques of this disclosure, communication unit(s) 222 can receive input from one or more from one or more remote advertising party devices, and this received input from one or more from one or more remote advertising party devices can be stored at the advertiser input database 212. The input received from the one or more from one or more remote advertising party devices and stored at the advertiser input database 212 can be on an individual third party advertiser basis, such that the received input can be stored at the advertiser input database 212 on an individual third party advertiser account basis. As noted previously, a third party advertiser can be a person or entity who provides compensation to a digital content provider (e.g., a person or entity who uses the computing device 105) in exchange for the digital content provider including advertising content specified by the advertising party present in a generated advertising skit.

Various types of input can be received from the one or more remote advertising party devices, of a third party advertiser, and stored at the advertiser input database 212. For example, input received from the one or more from one or more remote advertising party devices, of a third party advertiser, and stored at the advertiser input database 212 can include received selection of at least one advertising placement element that is to be included in a plurality of advertising skits (e.g., each having a common skit content theme) and/or received selection of at least one advertising alignment for the plurality of advertising skits (e.g., each having the skit content theme). For instance, the received selection of at least one advertising placement element that is to be included in a plurality of advertising skits can include received selection of at least one of: a primary role placement for an advertising element (e.g., character) across the skit content theme of the plurality of advertising skits, and a secondary role placement for an advertising element (e.g., character) across the skit content theme of the plurality of advertising skits. And, for instance, the received selection of at least one advertising alignment for the plurality of advertising skits can include received selection of at least one of: a hero alignment for an advertising element across the skit content theme of the plurality of advertising skits, an anti-hero alignment for an advertising element across the skit content theme of the plurality of advertising skits, and a neutral alignment for an advertising element across the skit content theme of the plurality of advertising skits.

In a further embodiment, the types of input that can be received from the one or more from one or more remote advertising party devices, of a third party advertiser, and stored at the advertiser input database 212 can include one or more other types of received input in addition to the received selection of at least one advertising placement element that is to be included in a plurality of advertising skits and/or received selection of at least one advertising alignment for the plurality of advertising skits. For example, in such a further embodiment, the received input from the one or more from one or more remote advertising party devices, of a third party advertiser, and stored at the advertiser input database 212 can include, in addition to the received selection of at least one advertising placement element that is to be included in a plurality of advertising skits and/or received selection of at least one advertising alignment for the plurality of advertising skits, any one or more (e.g., each of) the following types of received selection input: advertising content instructions specifying the content of the advertisement (e.g., text, logo, color, brand, etc.), advertising content display shape, advertising content display image, preferred target viewing audience geography, acceptable target viewing audience geography (e.g., larger geographic set that includes as a subset the preferred target viewing audience geography), preferred viewing audience demographic characteristics, acceptable viewing audience demographic characteristics (e.g., larger demographic set that include as a subset the preferred viewing audience demographic characteristics), preferred desired advertisement outcome (e.g., view engagement, predefined viewer input in response to advertisement skit (e.g., site visit), etc.), preferred advertising skit theme, preferred advertising skit content (e.g., type of character, defined category of character interaction(s)), skit content theme category opt-out, preferred industry types of any additional advertising content included in a same advertising skit, and industry type of any additional advertising content included in a same advertising skit opt-out. As noted, any one or more of such received section input from a third party advertiser can be stored at the advertiser input database 212 and used to generate one or more advertising skits.

Various types of input, such as advertising skit parameters, can be received (e.g., from a user of the computing device 105) and stored at the advertising skit database 214. For example, advertising skit parameters stored at the advertising skit database 214 can include any one or more (e.g., each of) the following types of advertising skit parameters: advertising skit time duration of a corresponding advertising skit, number of advertising content populatable advertising elements of a corresponding advertising skit, a plurality of advertising skit content theme categories, usage history associated with a corresponding advertising skit, applicable viewing audience geography, and viewer interaction with a corresponding advertising skit (e.g., view interaction with a corresponding skit content theme as well as viewer interaction with specific species of advertising skits of that corresponding skit content theme genus).

Various types of input, such as viewing party characteristics, can be received from the one or more remote viewing devices, of a remote viewing party, and stored at the viewer database 216. For example, viewing party characteristics stored at the viewer database 216 can include any one or more (e.g., each of) the following types of viewing party characteristics: advertising skit display event unique identification, advertising content unique record identification, advertising skit unique record identification, advertising skit display event date/time, advertising skit display event time duration, advertising skit display event completion flag, alignment of advertising content in a displayed corresponding advertising skit, advertising placement element of advertising content in a displayed corresponding advertising skit, unique viewing party identifier, viewing party internet protocol (IP) address, viewing party geographic location, viewing party demographic profile, viewing party interaction(s) with a corresponding advertising skit during the time duration of the corresponding advertising skit.

The data stored at one or more of the advertiser input database 212, advertising skit database 214, and viewer database 216 can be used by the processor(s) 202 according to the computer readable instructions stored at the advertising skit generation module 120. As one non-limiting example, the computer readable instructions stored at the advertising skit generation module 120, when executed, can cause the processor(s) 202 to utilize one or more look-up tables, stored at the advertising skit generation module 120, to use tagged correspondence, included at the look-up table(s), between data stored at the advertiser input database 212, advertising skit database 214, and/or viewer database 216. For instance, the advertising skit generation module 120 can store one or more such look-up tables with tagged correspondence between data stored at the advertiser input database 212, advertising skit database 214, and/or viewer database 216 to use data stored at the advertiser input database 212 to: (i) select one or more advertising skits (e.g., a plurality of advertising skits having a common skit content theme) from the advertising skit database 214 according to correspondence between the selected one or more advertising skits and the data stored at the advertiser input database 212, and (ii) select one or more viewing parties at one or more remote viewing devices from the viewer database 216 to provide the selected one or more advertising skits for display according to correspondence between the selected one or more viewing parties at one or more remote viewing devices and the data stored at the advertiser input database 212. Accordingly, in this way, the data stored at advertiser input database 212, advertising skit database 214, and/or viewer database 216 can be used to tailor the generation of, and provision of, an advertising skit, or a plurality of advertising skits each of a common skit content theme, such that the generated advertising skit(s) satisfy any one or more of the predetermined advertiser inputs stored at the advertiser input database 212, predetermined advertising skit characteristics stored at the advertising skit database 214, and/or predetermined viewing audience characteristics stored at the viewer database 216. This can allow for efficient advertising skit generation at scale in a way that complies with a variety of predetermined input constraints stored at the storage device 210.

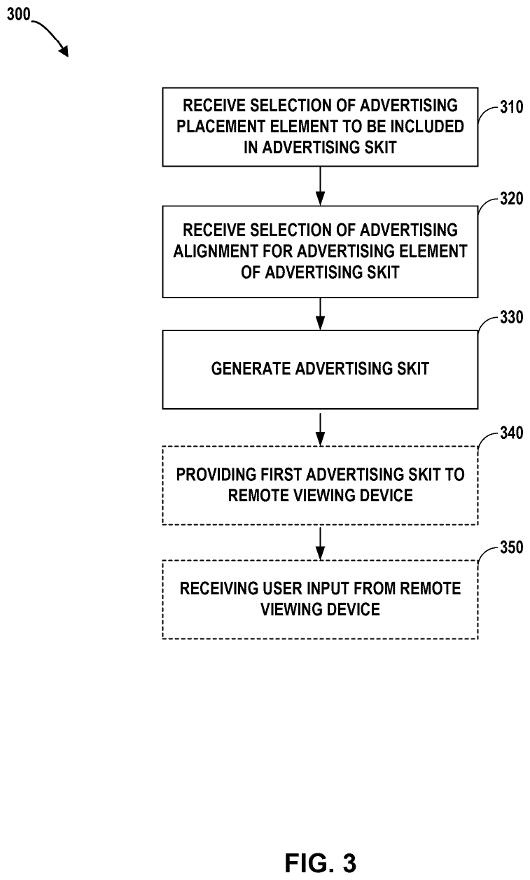

FIG. 3 is a flow diagram of an embodiment of a method 300 for generating an advertising skit. The method 300 can be carried out, for example, using any one or more embodiments of the system and/or computing device described elsewhere herein.

At step 310, the method 300 includes receiving selection of at least one advertising placement element that is to be included in a plurality of advertising skits each having a skit content theme. The received selection of the at least one advertising placement element can include selection of at least one of: a primary role placement for an advertising element across the skit content theme of the plurality of advertising skits, and a secondary role placement for an advertising element across the skit content theme of the plurality of advertising skits. For example, receiving selection of the primary role placement for the advertising element can include receiving selection of a main character role placement for the advertising element across the skit content theme of the plurality of advertising skits. And, for example, receiving selection of the secondary role placement for the advertising element can include receiving selection of at least one of: a supporting character role placement for the advertising element across the skit content theme of the plurality of advertising skits, and an environment element role placement for the advertising element across the skit content theme of the plurality of advertising skits. In further embodiments, step 310 can additionally include using any one or more of the other received types of advertising party data stored at the advertiser input database and described elsewhere herein.

At step 320, the method 300 includes receiving selection of at least one advertising alignment for the plurality of advertising skits each having the skit content theme. The received selection of the at least one advertising alignment can include selection of at least one of: a hero alignment for an advertising element across the skit content theme of the plurality of advertising skits, an anti-hero alignment for an advertising element across the skit content theme of the plurality of advertising skits, and a neutral alignment for an advertising element across the skit content theme of the plurality of advertising skits.

At step 330, the method 300 includes generating a first advertising skit of the plurality of advertising skits, with the first advertising skit including the skit content theme. The first advertising skit can be generated to include a first advertising content at a first advertising element based on the received selection of the at least one advertising placement element. And, the first advertising skit can be generated to include the first advertising content in a first advertising alignment at the first advertising element based on the received selection of the at least one advertising alignment.

For example, at step 330, the first advertising skit can be generated to include the first advertising content at the first advertising element as well as a second, different advertising content at a second, different advertising element. For instance, in doing so, the first advertising skit can be generated to include the first advertising content at the main character role placement as the first advertising element based on the received selection, from a first party (e.g., a first third party advertiser), of the at least one advertising placement element being received selection of the main character role placement for the advertising element across the skit content theme of the plurality of advertising skits. Similarly, the first advertising skit can be generated to include (i) the second, different advertising content at the supporting character role placement as the second, different advertising element based on the received selection, from a second, different party (e.g., a second, different third party advertiser), of the at least one advertising placement element being received selection of the supporting character role placement for the advertising element across the skit content theme of the plurality of advertising skits, or (ii) the second, different advertising content at the environment element role placement as the second, different advertising element based on the received selection, from the second, different party (e.g., a second, different third party advertiser), of the at least one advertising placement element being received selection of the environment element role placement for the advertising element across the skit content theme of the plurality of advertising skits.

In a further embodiment of the method 300, the method 300 can additionally include, after generating the first advertising skit at step 330, at step 340 providing the first advertising skit of the plurality of advertising skits to a remote viewing device, and, at step 350, receiving user input from the remote viewing device, with this received user input being associated with the first advertising skit. As one example, when the received user input at step 350, associated with the first advertising skit, matches a first preset threshold, the method 300 can, in one embodiment, then further include generating a second, different advertising skit of the plurality of advertising skits, with this second, different advertising skit including a common skit content theme with the first advertising skit at which the user input was received and matched the first preset threshold. In particular instance, the second advertising skit can be generated to include a second advertising element, which is different than the first advertising element of the first advertising skit, in place of the first advertising element of the first advertising skit. And in such particular instance, this second, now swapped in, advertising element can be selected based on the received selection of the at least one advertising placement element (e.g., from a third party advertiser).

In addition to using the received selection of at least one advertising placement element that is to be included in the plurality of advertising skits each having the skit content theme and the received selection of at least one advertising alignment for the plurality of advertising skits each having the skit content theme, other received input from a third party advertiser (e.g., and stored at the advertiser input database) can be used, including additionally any one or more of the types data described previously herein as can be received and stored at the advertiser database.

As one such example, the method 300 could additionally include using a received selection, from a third party advertiser of a first skit content theme category. As such, the method 300 can include receiving, from a first party (e.g., a first advertising party), selection of a first skit content theme category, where the first skit content theme category includes a first plurality of advertising skits each having a first, common skit content theme. For instance, the received selection of the first skit content theme category can be a selection of the first skit content theme category amongst a plurality of skit content theme categories that each having a plurality of advertising skits of a common skit content theme associated therewith. Such subgroups of plurality of skits associated with individual skit content theme categories can be saved, for example, at the advertising skit database and the advertising party can be presented with a list of the available skit content theme categories from which to make the skit content theme category selection. Then, in this particular embodiment of the method 300, generating the first advertising skit can include generating the first advertising skit as one of the first plurality of advertising skits each having the first, common skit content theme based on the received selection of the first skit content theme category. And, as noted, this first advertising skit can be generated additionally using at least the received selection of at least one advertising placement element that is to be included in the plurality of advertising skits each having the skit content theme and the received selection of at least one advertising alignment for the plurality of advertising skits each having the skit content theme.

As another example, method 300 could additionally include using a received selection of a first viewer characteristic to generate the first advertising skit. As such, the method 300 can include receiving, from a first party (e.g., a first advertising party), selection of a first viewer characteristic (e.g., a first viewer age, geographic location, past advertising skit viewing and/or interaction history, etc.). Then, the method 300 can include selecting a first skit content theme category from a plurality of skit content theme categories based on the first skit content theme category being associated with the received first viewer characteristic. For instance, the first skit content theme category can include a first plurality of advertising skits each having a first, common skit content theme, and the first, common skit content theme can be associated with the received first viewer characteristic. Then, the method 300 can include providing, to a remote viewing device associated with the first viewer characteristic, the first advertising skit as an advertising skit selected from the first skit content theme category. Thus, this example can leverage one or more characteristics of a particular viewer for use in selecting a skit content theme category, from a plurality of skit content theme categories (e.g., saved at the advertising skit database), that is better targeted to that particular viewer. As such, it can be useful to have a wide range of skit content theme categories targeted to viewers with different characteristics.

And as a further such example, method 300 could additionally include using a received selection of a skit content theme category opt-out. As such, the method 300 can include receiving, from a first party (e.g., a first advertising party), selection of a skit content theme category opt-out for a first skit content theme category that includes a first plurality of advertising skits each having a first, common skit content theme. For instance, the received selection of a skit content theme category opt-out can be a selection of a skit content theme, and thereby any advertising skits that include such skit content theme, for which the selecting first party (e.g., a first advertising party) desires to be excluded from association with that selecting first party's specified advertising content to otherwise be included in one or more other advertising skits. Then, the method 300 can include excluding the first plurality of advertising skits each having the first, common skit content theme, which the first party (e.g., a first advertising party) selected to be excluded from association with that selecting first party's specified advertising content, when generating the first advertising skit.

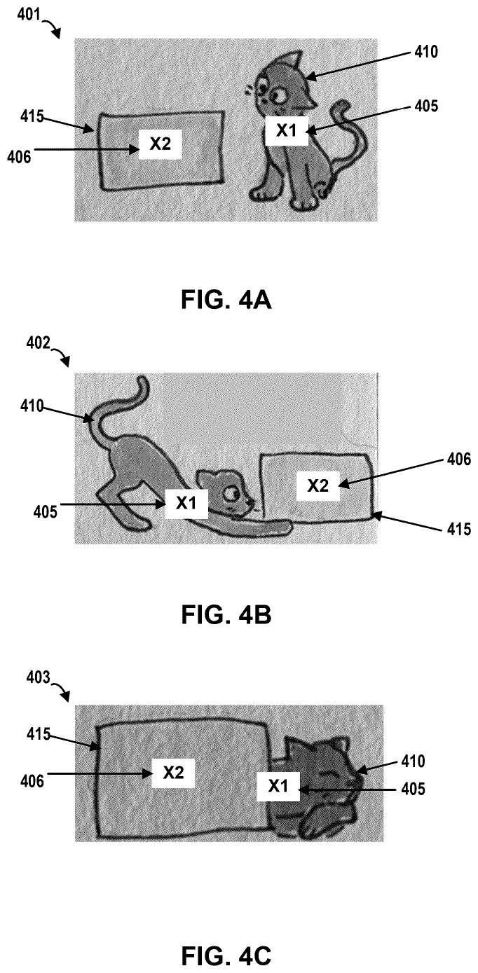

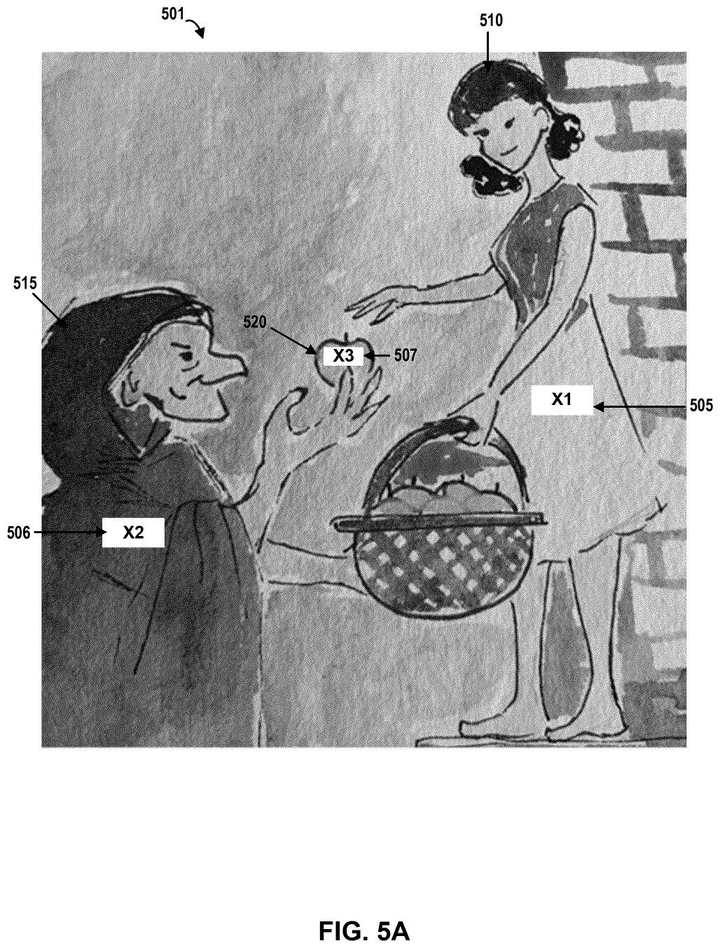

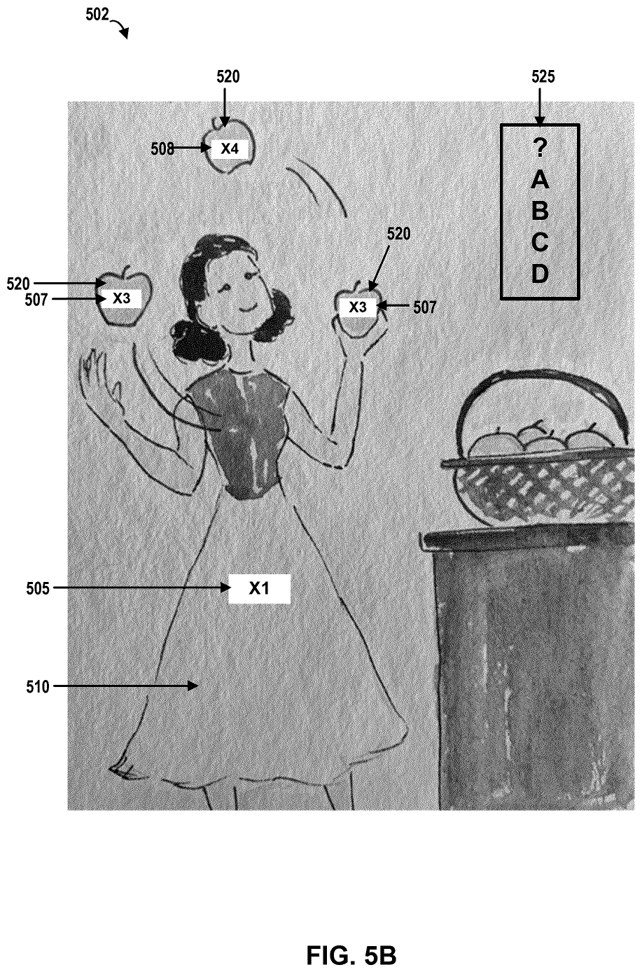

To help illustrate exemplary, non-limiting embodiments of generated advertising skits, FIGS. 4A-5B are referenced as follows.

FIGS. 4A-4C show an embodiment of a plurality of advertising skits 401, 402, 403 each having a common skit content theme. FIG. 4A illustrates an embodiment of a first advertising skit 401 of the plurality of advertising skits having the common skit content theme, FIG. 4B illustrates an embodiment of a second advertising skit 402 of the plurality of advertising skits having the common skit content theme, and FIG. 4C illustrates an embodiment of a third advertising skit 403 of the plurality of advertising skits having the common skit content theme.

In the illustrated example, each of the plurality of advertising skits 401, 402, 403 is generated to include a first advertising content 405 (e.g., an advertising party's brand in text, logo symbol, or other symbolic or textual representation associated with the selecting advertising party) and a second advertising content 406 (e.g., an advertising party's brand in text, logo symbol, or other symbolic or textual representation associated with the selecting advertising party). More specifically, in this example, each of the plurality of advertising skits 401, 402, 403 is generated to include the first advertising content 405 at a first advertising element 410 based on the received selection (e.g., from a first advertising party) of the at least one advertising placement element. Also in this example, each of the plurality of advertising skits 401, 402, 403 is generated to include the second advertising content 406 at a second advertising element 415 based on the received selection (e.g., from a second, different advertising party) of the at least one advertising placement element. For instance, here the first advertising element 410 is a character, a digital, animated cat, who serves a primary role across the skit content theme of the plurality of advertising skits 401, 402, 403, while the second advertising element 415 is a secondary role across the skit content theme of the plurality of advertising skits 401, 402, 403. As noted previously, the advertising skits 401, 402, 403 can be generated to include the first advertising content 405 at the first advertising element 410 and the second, different advertising content 406 at the second, different advertising element 415.

Accordingly, the plurality of advertising skits 401, 402, 403, as illustrated, can be generated, at least in part, to include the first advertising content 405 at the first advertising element 410 based on received selection (e.g., from a first advertising party) of the at least one advertising placement element as a primary role placement for the advertising element, here the first advertising element 410 as the character in the form of a digital, animated cat. More specifically, the plurality of advertising skits 401, 402, 403, as illustrated, can be generated, at least in part, to include the first advertising content 405 at the first advertising element 410 based on received selection (e.g., from a first advertising party) of the at least one advertising placement element as a primary role placement for the advertising element specifically as a main character role placement for such advertising element—the first advertising element 410—across the skit content theme of the plurality of advertising skits 401, 402, 403. Likewise, the plurality of advertising skits 401, 402, 403, as illustrated, can be generated, at least in part, to include the second advertising content 406 at the second advertising element 415 based on received selection (e.g., from a second, different advertising party) of the at least one advertising placement element as a secondary role placement for the advertising element, here the second advertising element 415 as a supporting character/prop in the form of a digital, animated box. More specifically, the plurality of advertising skits 401, 402, 403, as illustrated, can be generated, at least in part, to include the second advertising content 406 at the second advertising element 415 based on received selection (e.g., from a second, different advertising party) of the at least one advertising placement element as a secondary role placement for the advertising element specifically as a supporting character role placement for such advertising element—the second advertising element 415—across the skit content theme of the plurality of advertising skits 401, 402, 403.

In addition, the plurality of advertising skits 401, 402, 403, as illustrated, can be generated, at least in part, to include the first advertising content 405 at the first advertising element 410 based on received selection (e.g., from a first advertising party) of the at least one advertising alignment as a type of hero alignment for the advertising element, here the digital, animated cat acting as a type of hero as the first advertising element 410. This received selection of the type of hero alignment for the first advertising element 410 can result in the plurality of advertising skits 401, 402, 403 being generated to include actions taken by the first advertising element 410—here the digital, animated cat—that are intended to be perceived as positive, or favorable, by a viewing audience. Likewise, the plurality of advertising skits 401, 402, 403, as illustrated, can be generated, at least in part, to include the second advertising content 406 at the second advertising element 415 based on received selection (e.g., from a second, different advertising party) of the at least one advertising alignment as a type of neutral alignment for the advertising element, here the digital, animated box, playing a role, as the second advertising element 415, in the advertising skits 401, 402, 403 that is intended to be perceived as neutral by a viewing audience. Namely, in this example, the digital, animated box, plays a role, as the second advertising element 415, that is interacted with by the main character—the first advertising element 410 as the cat—but the digital, animated box, playing a neutral alignment role as the second advertising element 415 does not take actions intended to be perceived by a viewing audience as positive or negative.

As noted, each of the plurality of advertising skits 401, 402, 403 has a common skit content theme. For the embodiment of the advertising skits 401, 402, 403 that common skit content theme can be a cat interacting with a box, and those interactions can take a variety of forms which, as different forms of interactions take place between the cat and the box, different results with respect to the cat and/or the box occur.

Once the plurality of advertising skits 401, 402, 403 are generated, the plurality of advertising skits 401, 402, 403 can be provided to a remote viewing device. As noted previously herein, a viewing party at the remote viewing device can interact with the plurality of advertising skits 401, 402, 403 and, as such, user input from the remote viewing device can be received. Namely, such viewing party interaction with the plurality of advertising skits 401, 402, 403 at the remote viewing device can be user input, from the viewing party, at the remote viewing device in the form of received user input that is associated with at least one of the advertising skits 401, 402, 403. This can include, for instance, receiving user input from the remote viewing device in the form of input engagement at one of the first advertising element 410 and the second advertising element 415. As one specific such example, user input at the remote viewing device in the form of input engagement (e.g., touching via a touchscreen at the remote viewing device, hovering over or clicking on via a movable cursor icon at the remote viewing device) at the first advertising element 410 can be used a first preset threshold. When received user input, from the remote viewing device and associated with the first advertising skit 401, matches this first preset threshold, the second advertising skit 402 can be generated and include the common skit content theme.

For instance, receiving user input at the remote viewing device in the form of input engagement that matches the first preset threshold that is associated with the first advertising element 410 can cause the second advertising skit 402 to be generated with a change in the advertising element 410 relative to the advertising element 410 as displayed for the first advertising skit 401. As one such example, such a change in the advertising element 410, as a result of receiving user input at the remote viewing device in the form of input engagement that matches the first preset threshold that is associated with the first advertising element 410, can cause the first advertising element 410 to move relative to the second advertising element 415 and/or cause the first advertising element 410 to take a different action with respect to the second advertising element 415. As can be seen from the illustrated sequence of advertising skits from the first advertising skit 401 to the second advertising skit 402, a change in the first advertising element 410, as a result of receiving user input at the remote viewing device in the form of input engagement that matches the first preset threshold that is associated with the first advertising element 410, can cause the first advertising element 410 to move to a different orientation (e.g., now located at an opposite side of the second advertising element 415) with respect to the second advertising element 415 and cause the first advertising element 410 to perform a different action with respect to the second advertising element 415 (e.g., change from the first advertising element 405 looking at, but not touching, the second advertising element 415 to now in the second advertising skit 402 pushing the second advertising element 415). Likewise, as can be seen from the illustrated sequence of advertising skits from the second advertising skit 402 to the third advertising skit 403, another change in the first advertising element 410, as a result of receiving second, subsequent user input at the remote viewing device in the form of input engagement that matches the first preset threshold that is associated with the first advertising element 410, can cause the first advertising element 410 to move to a different orientation (e.g., now located partially inside of the second advertising element 415) with respect to the second advertising element 415 and cause the first advertising element 410 to perform a different action with respect to the second advertising element 415 (e.g., now no longer pushing the second advertising element 410 and instead using the second advertising element 410 as a bed).

Use of a preset threshold for assessing user input at the remote viewing device in the form of input engagement can likewise be used for user input at the remote viewing device in the form of input engagement with respect to the second advertising element 415. As one such illustrative example, as a result of receiving user input at the remote viewing device in the form of input engagement that matches a preset threshold that is associated with the second advertising element 415, a subsequent advertising skit can be generated to change type of prop/character used as the second advertising element 415. For instance, the animated box serving as the second advertising element 415 could be swapped out for a different animated prop/character that continues to serve the previously selected secondary role, in the neutral alignment, in such subsequent advertising skit.

Any such received user input at the remote viewing device in the form of input engagement that matches a preset threshold can be saved at the viewer database and used, in some embodiments, at least in part, to generate a subsequent advertising skit for that viewer associated with that remote viewing device.

FIGS. 5A-5B illustrate another embodiment of a plurality of advertising skits 501, 502 each having a common skit content theme. FIG. 5A illustrates an embodiment of a first advertising skit 501 of the plurality of advertising skits having the common skit content theme, and FIG. 5B illustrates an embodiment of a second advertising skit 502 of the plurality of advertising skits having the common skit content theme.

In the illustrated example, each of the plurality of advertising skits 501, 502 is generated to include a first advertising content 505 (e.g., an advertising party's brand in text, logo symbol, or other symbolic or textual representation associated with the selecting advertising party) a second advertising content 506 (e.g., an advertising party's brand in text, logo symbol, or other symbolic or textual representation associated with the selecting advertising party), and a third advertising content 507 (e.g., an advertising party's brand in text, logo symbol, or other symbolic or textual representation associated with the selecting advertising party). More specifically, in this example, each of the plurality of advertising skits 501, 502 is generated to include the first advertising content 505 at a first advertising element 510 based on the received selection (e.g., from a first advertising party) of the at least one advertising placement element. Also in this example, at least the first advertising skits 501 is generated to include the second advertising content 506 at a second advertising element 515 based on the received selection (e.g., from a second, different advertising party) of the at least one advertising placement element. And, also in this example, each of the plurality of advertising skits 501, 502 is generated to include the third advertising content 507 at a third advertising element 520 based on the received selection (e.g., from a third, different advertising party) of the at least one advertising placement element. For instance, here the first advertising element 510 is a character, a digital, animated person, who serves a primary role across the skit content theme of the plurality of advertising skits 501, 502. The second advertising element 515 is a character, a digital, animated person, who serves a secondary role across the skit content theme of the plurality of advertising skits 501, 502, though the second advertising element 515, owing to its secondary role, may not be present in all advertising skits of the skit content theme. And the third advertising element 520 is a prop, a digital, animated apple, which serves a secondary role across the skit content theme of the plurality of advertising skits 501, 502. As noted previously, the advertising skits 501, 502 can be generated to include the first advertising content 505 at the first advertising element 510, the second, different advertising content 506 at the second, different advertising element 515, and the third, different advertising content 507 at the third, different advertising element 520.

Accordingly, the plurality of advertising skits 501, 502, as illustrated, can be generated, at least in part, to include the first advertising content 505 at the first advertising element 510 based on received selection (e.g., from a first advertising party) of the at least one advertising placement element as a primary role placement for the advertising element, here the first advertising element 510 as the character in the form of a digital, animated person (e.g., princess). More specifically, the plurality of advertising skits 501, 502, as illustrated, can be generated, at least in part, to include the first advertising content 505 at the first advertising element 510 based on received selection (e.g., from a first advertising party) of the at least one advertising placement element as a primary role placement for the advertising element specifically as a main character role placement for such advertising element—the first advertising element 510—across the skit content theme of the plurality of advertising skits 501, 502. Likewise, at least some of the plurality of advertising skits 501, 502 can be generated, at least in part, to include the second advertising content 506 at the second advertising element 515 based on received selection (e.g., from a second, different advertising party) of the at least one advertising placement element as a secondary role placement for the advertising element, here the second advertising element 515 as a supporting character in the form of a digital, animated person (e.g., wicked witch). More specifically, at least some of the plurality of advertising skits 501, 502 can be generated, at least in part, to include the second advertising content 506 at the second advertising element 515 based on received selection (e.g., from a second, different advertising party) of the at least one advertising placement element as a secondary role placement for the advertising element specifically as a supporting character role placement for such advertising element—the second advertising element 515—across the skit content theme of the plurality of advertising skits 501, 502. Likewise, at least some of the plurality of advertising skits 501, 502 can be generated, at least in part, to include the third advertising content 507 at the third advertising element 520 based on received selection (e.g., from a third, different advertising party) of the at least one advertising placement element as a secondary role placement for the advertising element, here the third advertising element 520 as a supporting prop in the form of a digital, animated apple. More specifically, at least some of the plurality of advertising skits 501, 502 can be generated, at least in part, to include the third advertising content 507 at the third advertising element 520 based on received selection (e.g., from a third, different advertising party) of the at least one advertising placement element as a secondary role placement for the advertising element specifically as an environment element role placement for such advertising element—the third advertising element 520—across the skit content theme of the plurality of advertising skits 501, 502.

In addition, the plurality of advertising skits 501, 502, as illustrated, can be generated, at least in part, to include the first advertising content 505 at the first advertising element 510 based on received selection (e.g., from a first advertising party) of the at least one advertising alignment as a type of hero alignment for the advertising element, here the digital, animated person (e.g., princess) acting as a type of hero as the first advertising element 510. This received selection of the type of hero alignment for the first advertising element 510 can result in the plurality of advertising skits 501, 502 being generated to include actions taken by the first advertising element 510—here the digital, animated person (e.g., princess)—that are intended to be perceived as positive, or favorable, by a viewing audience. Likewise, the plurality of advertising skits 501, 502, as illustrated, can be generated, at least in part, to include the second advertising content 506 at the second advertising element 515 based on received selection (e.g., from a second, different advertising party) of the at least one advertising alignment as a type of anti-hero alignment for the advertising element, here the digital, animated person (e.g., wicked witch), playing a role, as the second advertising element 515, in at least some of the advertising skits 501, 502 that is intended to be perceived as negative, or unfavorable, by a viewing audience. Namely, in this example, the digital, animated person plays a role, as the second advertising element 515, that attempts to induce the first advertising element 510 into taking a negative, or harmful, action (e.g., eating a poisonous apple). And, likewise, the plurality of advertising skits 501, 502, as illustrated, can be generated, at least in part, to include the third advertising content 507 at the third advertising element 520 based on received selection (e.g., from a third, different advertising party) of the at least one advertising alignment as a type of neutral alignment for the advertising element, here the digital, animated prop (e.g., apple), playing a role, as the third advertising element 520, that is intended to be perceived as neutral by a viewing audience. Namely, in this example, the digital, animated prop (e.g., apple) plays a role, as the third advertising element 520, that is interacted with by each of the main character—the first advertising element 510 as the princess—and the supporting character—the second advertising element 515 as the wicked witch—but the digital, animated apple, playing a neutral alignment role as the third advertising element 520 does not take actions intended to be perceived by a viewing audience as positive or negative.

As noted, each of the plurality of advertising skits 501, 502 has a common skit content theme. For the embodiment of the advertising skits 501, 502 that common skit content theme can be a princess being tempted into one or more negative actions and, in lieu of taking such tempted negative actions, instead responds to the tempting by taking a comical or positive action.

Once the plurality of advertising skits 501, 502 are generated, the plurality of advertising skits 501, 502 can be provided to a remote viewing device. As noted previously herein, the advertising skits 501, 502 can be provided to the remote viewing device in a way that is configured to receive interaction, with one or more of the advertising skits 501, 502, from a viewing party at the remote viewing device, and, as such, user input from the remote viewing device can be received. Namely, such viewing party interaction with the plurality of advertising skits 501, 502 at the remote viewing device can be user input, from the viewing party, at the remote viewing device in the form of received user input that is associated with at least one of the advertising skits 501, 502. This can include, for instance, receiving user input from the remote viewing device in the form of input engagement at at least one of the first advertising element 510, the second advertising element 515, and the third advertising element 520. As one specific such example, user input at the remote viewing device in the form of input engagement (e.g., touching via a touchscreen at the remote viewing device, hovering over and/or clicking on via a movable cursor icon at the remote viewing device) at the first advertising element 510 can be used a first preset threshold. When received user input, from the remote viewing device and associated with the first advertising skit 501, matches this first preset threshold, the second advertising skit 402 can be generated and include the common skit content theme.

For example, with respect to the second advertising element 515 in the anti-hero alignment, when such received user input at the remote viewing device in the form of input engagement that matches the first preset threshold, the second advertising element 515 in the anti-hero alignment can be removed from a subsequent, second advertising skit 502.

As another example, with respect to the third advertising element 520 in the neutral alignment, when such received user input at the remote viewing device in the form of input engagement that matches the first preset threshold, advertising content 507 included at the third advertising elements 520, in the neutral alignment, can be replaced with different advertising content. For example, as illustrated at the example of FIG. 5B, user input, associated with one of the third advertising elements 520 (e.g., touching via a touchscreen at the remote viewing device at a region corresponding to the display of one of the third advertising elements 520, hovering over or clicking on via a movable cursor icon at the remote viewing device at a region corresponding to the display of one of the third advertising elements 520), can be received and thereby cause the advertising content 507 (e.g., “X3”) at the one of the third advertising elements 520 to be replaced with different advertising content 508 (e.g., “X4”). Similar interaction and resulting functionality can apply additionally, or alternatively, to the first advertising element 510 and/or the second advertising element 515.

In certain examples, user input at the remote viewing device in the form of input engagement with one or more advertising skits 501, 502 can be received in response to a prompt 525 provided with the one or more advertising skits 501, 502. As one such example, referring to the embodiment of the advertising skit 502, a plurality of third advertising elements 520 can be displayed with the advertising skit 502, where at least one advertising content 508 at at least one third advertising element 520 differs from one or more other advertising content 507 at at least one other third advertising element 520. The prompt 525 can be displayed, at the advertising skit 502, and include a question (e.g., “?”) along with two or more predetermined possible answers to the question (e.g., “A,” “B,” “C, “D”). The user input can be received at the remote viewing device in the form of input engagement, with advertising skit 502, selecting one of the predetermined possible answers to the question at the prompt 525. The preset threshold to which the input engagement, with advertising skit 502, selecting one of the predetermined possible answers to the question at the prompt 525 can be compared can be a predetermined correct answer (e.g., one or more of the predetermined possible answers presented at the prompt 525) to the question provided at the prompt 525. For instance, the question included at the prompt 525 can be a type of memory test which can ask a user, viewing the advertising skit 502, at a remote viewing device to recall which of the predetermined possible correct answers provided at the prompt 525 was, or was not, advertising content displayed in the advertising skit 502 (e.g., predetermined possible correct answers provided at the prompt 525 include advertising content “X2,” advertising content “X3,” and advertising content “X4” and since advertising content “X2” was not displayed in the advertising skit 502 user input at the remote viewing device selecting advertising content “X2” would match the preset threshold—in this example the correct answer in response to the prompt 525). In one specific such example, when the selected one of the predetermined possible answers to the question matches the preset threshold (e.g., the selected one of the predetermined possible answers to the question matches the predetermined correct answer), an account associated with the user at the remote viewing device can receive a reward credited to such account.

As discussed previously, any such received user input at the remote viewing device in the form of input engagement that matches a preset threshold can be saved at the viewer database and used, in some embodiments, at least in part, to generate a subsequent advertising skit for that viewer associated with that remote viewing device.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit (e.g., programmable microprocessor). Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
receiving selection of at least one advertising placement element that is to be included in a plurality of advertising skits each having a skit content theme, wherein the received selection of the at least one advertising placement element includes selection of at least one of: a primary role placement for an advertising element across the skit content theme of the plurality of advertising skits, and a secondary role placement for an advertising element across the skit content theme of the plurality of advertising skits;
receiving selection of at least one advertising alignment for the plurality of advertising skits each having the skit content theme, wherein the received selection of the at least one advertising alignment includes selection of at least one of: a hero alignment for an advertising element across the skit content theme of the plurality of advertising skits, an anti-hero alignment for an advertising element across the skit content theme of the plurality of advertising skits, and a neutral alignment for an advertising element across the skit content theme of the plurality of advertising skits; and
generating a first advertising skit of the plurality of advertising skits, the first advertising skit including the skit content theme, wherein the first advertising skit is generated to include a first advertising content at a first advertising element based on the received selection of the at least one advertising placement element, and wherein the first advertising skit is generated to include the first advertising content in a first advertising alignment at the first advertising element based on the received selection of the at least one advertising alignment.

2. The method of claim 1, wherein receiving selection of the primary role placement for the advertising element includes receiving selection of a main character role placement for the advertising element across the skit content theme of the plurality of advertising skits, and wherein receiving selection of the secondary role placement for the advertising element includes receiving selection of at least one of: a supporting character role placement for the advertising element across the skit content theme of the plurality of advertising skits, and an environment element role placement for the advertising element across the skit content theme of the plurality of advertising skits.

3. The method of claim 2, wherein the first advertising skit is generated to include the first advertising content at the first advertising element and a second, different advertising content at a second, different advertising element.

4. The method of claim 3,
wherein the first advertising skit is generated to include the first advertising content at the main character role placement as the first advertising element based on the received selection, from a first party, of the at least one advertising placement element being received selection of the main character role placement for the advertising element across the skit content theme of the plurality of advertising skits, and
wherein the first advertising skit is generated to include (i) the second, different advertising content at the supporting character role placement as the second, different advertising element based on the received selection, from a second, different party, of the at least one advertising placement element being received selection of the supporting character role placement for the advertising element across the skit content theme of the plurality of advertising skits, or (ii) the second, different advertising content at the environment element role placement as the second, different advertising element based on the received selection, from the second, different party, of the at least one advertising placement element being received selection of the environment element role placement for the advertising element across the skit content theme of the plurality of advertising skits.

5. The method of claim 1, further comprising:
providing the first advertising skit of the plurality of advertising skits to a remote viewing device; and
receiving user input from the remote viewing device, the received user input being associated with the first advertising skit.

6. The method of claim 5, further comprising:
when the received user input, associated with the first advertising skit, matches a first preset threshold, generating a second advertising skit of the plurality of advertising skits, the second advertising skit including the skit content theme.

7. The method of claim 6, wherein the second advertising skit is generated to include a second advertising element, which is different than the first advertising element, in place of the first advertising element, and wherein the second advertising element is selected based on the received selection of the at least one advertising placement element.

8. The method of claim 1, further comprising:
receiving, from a first party, selection of a first skit content theme category, the first skit content theme category including a first plurality of advertising skits each having a first, common skit content theme; and
wherein generating the first advertising skit includes generating the first advertising skit as one of the first plurality of advertising skits each having the first, common skit content theme based on the received selection of the first skit content theme category.

9. The method of claim 1, further comprising:
receiving, from a first party, selection of a first viewer characteristic;
selecting a first skit content theme category from a plurality of skit content theme categories based on the first skit content theme category being associated with the received first viewer characteristic, the first skit content theme category including a first plurality of advertising skits each having a first, common skit content theme, the first, common skit content theme being associated with the received first viewer characteristic; and
providing, to a remote viewing device associated with the first viewer characteristic, the first advertising skit as an advertising skit selected from the first skit content theme category.

10. The method of claim 1, further comprising:
receiving, from a first party, selection of a skit content theme category opt-out for a first skit content theme category that includes a first plurality of advertising skits each having a first, common skit content theme; and
excluding the first plurality of advertising skits each having the first, common skit content theme when generating the first advertising skit.

11. An apparatus having programmable processing circuitry to:
receive selection of at least one advertising placement element that is to be included in a plurality of advertising skits each having a skit content theme, wherein the received selection of the at least one advertising placement element includes selection of at least one of: a primary role placement for an advertising element across the skit content theme of the plurality of advertising skits, and a secondary role placement for an advertising element across the skit content theme of the plurality of advertising skits;
receive selection of at least one advertising alignment for the plurality of advertising skits each having the skit content theme, wherein the received selection of the at least one advertising alignment includes selection of at least one of: a hero alignment for an advertising element across the skit content theme of the plurality of advertising skits, an anti-hero alignment for an advertising element across the skit content theme of the plurality of advertising skits, and a neutral alignment for an advertising element across the skit content theme of the plurality of advertising skits; and
generate a first advertising skit of the plurality of advertising skits, the first advertising skit including the skit content theme, wherein the first advertising skit is generated to include a first advertising content at a first advertising element based on the received selection of the at least one advertising placement element, and wherein the first advertising skit is generated to include the first advertising content in a first advertising alignment at the first advertising element based on the received selection of the at least one advertising alignment.

12. The apparatus of claim 11, wherein the programmable processing circuitry is configured to receive selection of the primary role placement for the advertising element by receiving selection of a main character role placement for the advertising element across the skit content theme of the plurality of advertising skits, and wherein the programmable processing circuitry is configured to receive selection of the secondary role placement for the advertising element by receiving selection of at least one of: a supporting character role placement for the advertising element across the skit content theme of the plurality of advertising skits, and an environment element role placement for the advertising element across the skit content theme of the plurality of advertising skits.

13. The apparatus of claim 12, wherein the programmable processing circuitry is configured to generate the first advertising skit to include the first advertising content at the first advertising element and a second, different advertising content at a second, different advertising element.

14. The apparatus of claim 13,
wherein the programmable processing circuitry is configured to generate the first advertising skit to include the first advertising content at the main character role placement as the first advertising element based on the received selection, from a first party, of the at least one advertising placement element being received selection of the main character role placement for the advertising element across the skit content theme of the plurality of advertising skits, and
wherein the programmable processing circuitry is configured to generate the first advertising skit to include (i) the second, different advertising content at the supporting character role placement as the second, different advertising element based on the received selection, from a second, different party, of the at least one advertising placement element being received selection of the supporting character role placement for the advertising element across the skit content theme of the plurality of advertising skits, or (ii) the second, different advertising content at the environment element role placement as the second, different advertising element based on the received selection, from the second, different party, of the at least one advertising placement element being received selection of the environment element role placement for the advertising element across the skit content theme of the plurality of advertising skits.

15. The apparatus of claim 11, wherein the programmable processing circuitry is further configured to:
provide the first advertising skit of the plurality of advertising skits to a remote viewing device; and
receive user input from the remote viewing device, the received user input being associated with the first advertising skit.

16. The apparatus of claim 15, wherein the programmable processing circuitry is further configured to:
when the received user input, associated with the first advertising skit, matches a first preset threshold, generate a second advertising skit of the plurality of advertising skits, the second advertising skit including the skit content theme.

17. The apparatus of claim 16, wherein the programmable processing circuitry is configured to generate the second advertising skit to include a second advertising element, which is different than the first advertising element, in place of the first advertising element, and wherein the programmable processing circuitry is configured to select the second advertising element based on the received selection of the at least one advertising placement element.

18. The apparatus of claim 11, wherein the programmable processing circuitry is further configured to:
receive, from a first party, selection of a first skit content theme category, the first skit content theme category including a first plurality of advertising skits each having a first, common skit content theme; and
wherein the programmable processing circuitry is configured to generate the first advertising skit by generating the first advertising skit as one of the first plurality of advertising skits each having the first, common skit content theme based on the received selection of the first skit content theme category.

19. The apparatus of claim 11, wherein the programmable processing circuitry is further configured to:
receive, from a first party, selection of a first viewer characteristic;
select a first skit content theme category from a plurality of skit content theme categories based on the first skit content theme category being associated with the received first viewer characteristic, the first skit content theme category including a first plurality of advertising skits each having a first, common skit content theme, the first, common skit content theme being associated with the received first viewer characteristic; and
provide, to a remote viewing device associated with the first viewer characteristic, the first advertising skit as an advertising skit selected from the first skit content theme category.

20. The method of claim 11, further comprising:
receive, from a first party, selection of a skit content theme category opt-out for a first skit content theme category that includes a first plurality of advertising skits each having a first, common skit content theme; and
exclude the first plurality of advertising skits each having the first, common skit content theme when generating the first advertising skit.
